(19) United States
(12) Patent Application Publication
(10) Pub. No.: US 2018/0230290 A1
(43) Pub. Date: Aug. 16, 2018

(54) THERMALLY CONDUCTIVE POLYMER COMPOSITION

(71) Applicant: E I DU PONT DE NEMOURS AND COMPANY, Wilmington, DE (US)

(72) Inventors: Yuji Saga, Utsunomiya-shi (JP); Takeshi Kondo, Kanagawa (JP); Yuri Noma, Utsunomiya (JP); Takaaki Tomai, Miyagi (JP); Itaru Honma, Miyagi (JP)

(21) Appl. No.: 15/891,822

(22) Filed: Feb. 8, 2018

Related U.S. Application Data
(60) Provisional application No. 62/457,332, filed on Feb. 10, 2017.

(51) Int. Cl. C08K 3/38; C08L 23/06; C08L 23/12; C08L 23/16; C08L 23/22; C08L 25/06; C08L 25/10; C08L 27/06; C08L 27/12; C08L 33/08; C08L 63/04; C08L 65/02; C08L 75/04; C08L 79/08; C08L 81/06; C08J 5/18

(52) U.S. Cl. CPC C08K 3/38; C08L 2205/18; C08L 23/12; C08L 23/16; C08L 23/22; C08L 25/06; C08L 25/10; C08L 27/06; C08L 27/12; C08L 33/08; C08L 63/04; C08L 65/02; C08L 75/04; C08L 79/08; C08L 81/06; C08J 5/18; C08K 2003/385; C08K 2201/001; C08K 2201/003; C08K 2201/005; C08K 2201/006; C08K 2201/016; C08L 23/06

(57) ABSTRACT

The present invention relates to a thermally conductive polymer composition. The thermally conductive polymer composition comprises (a) 30 to 60 parts by weight of a polymer, and (b) 100 parts by weight of a boron nitride filler comprising, (b-1) 70 to 99 parts by weight of a spherical boron nitride filler, and (b-2) 1 to 30 parts by weight of a sheet boron nitride filler having a thickness of 5 to 500 nm, a surface area of 4 to 50 m²/g and an aspect ratio of 100:1 to 10000:1.

### FIELD OF THE INVENTION

The present invention relates to a thermally conductive polymer composition.

### TECHNICAL BACKGROUND OF THE INVENTION

A thermally conductive polymer composition is used in an electric component as a heat releaser.

US20150252242 discloses a thermoplastic resin composition. The thermoplastic resin composition contains 20 to 60 volume percent of thermoplastic resin and 40 to 80 volume percent of boron nitride.

### BRIEF SUMMARY OF THE INVENTION

An objective is to provide a thermally conductive polymer composition.

An aspect of the invention relates to a thermally conductive polymer composition comprising, (a) 30 to 60 parts by weight of a polymer, and (b) 100 parts by weight of a boron nitride filler comprising, (b-1) 70 to 99 parts by weight of a spherical boron nitride filler, and (b-2) 1 to 30 parts by weight of a sheet boron nitride filler having a thickness of 5 to 500 nm, a surface area of 4 to 50 m²/g and an aspect ratio of 100:1 to 10000:1.

Another aspect of the invention relates to a thermally conductive polymer film comprising (a) 30 to 60 parts by weight of a polymer, and (b) 100 parts by weight of a boron nitride filler comprising, (b-1) 70 to 99 parts by weight of a spherical boron nitride filler, and (b-2) 1 to 30 parts by weight of a sheet boron nitride filler having a thickness of 5 to 500 nm, a surface area of 4 to 50 m²/g and an aspect ratio of 100:1 to 10000:1.

Another aspect of the invention relates to a method of manufacturing a thermally conductive polymer layer comprises steps of: applying a thermally conductive polymer paste composition on a substrate, the thermally conductive polymer paste composition comprises (a) 30 to 60 parts by weight of a polymer, (b) 100 parts by weight of a boron nitride filler comprising, (b-1) 70 to 99 parts by weight of a spherical boron nitride filler and (b-2) 1 to 30 parts by weight of a sheet boron nitride filler having a thickness of 5 to 500 nm, a surface area of 4 to 50 m²/g and an aspect ratio of 100:1 to 10000:1, and (c) 2 to 60 parts by weight of a solvent; and drying the applied thermally conductive polymer paste composition.

A polymer composition having sufficient thermal conductivity can be provided by the present invention.

### BRIEF DESCRIPTION OF DRAWINGS

FIG. 1 is a schematic cross-sectional drawing of the thermally conductive polymer composition.

FIG. 2 is a schematic drawing of the process to make the sheet BN filler with a supercritical fluid reactor.

### DETAILED DESCRIPTION OF INVENTION

The thermally conductive polymer composition can be prepared by dispersing a boron nitride (BN) filler in an organic polymer. Solvent can be mixed together with the polymer to make it viscous so that the filler can be easily dispersed.

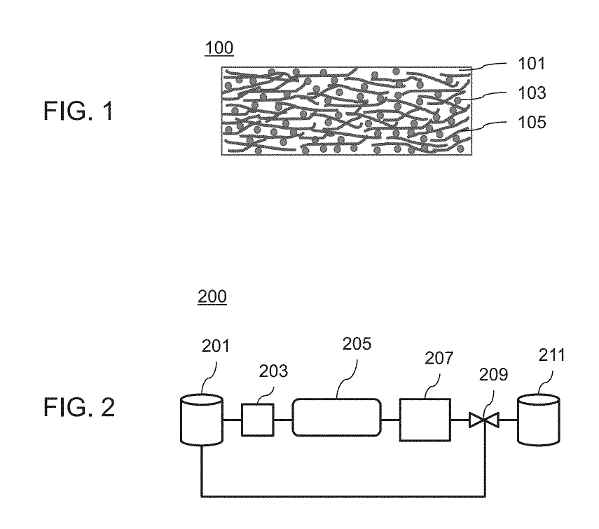

The thermally conductive polymer composition 100 comprises (a) a polymer 101 and (b) a boron nitride filler comprising (b-1) a spherical boron nitride filler 103 and (b-2) a sheet boron nitride filler 105 (FIG. 1). The thermally conductive polymer composition 100 exhibits satisfactory resistivity and thermal conductivity. Thermal conductivity of the thermally conductive polymer composition 100 is 3.4 W/mK or higher measured according to ASTM E-1461 in an embodiment. A proposed hypothesis is that the spherical BN filler 103 being sandwiched between the sheet BN filler 105 could thermally connect the sheet BN filler 105.

The thermally conductive polymer composition can be in the form of polymer pellets in an embodiment. The polymer pellets can be formed by a well known method, mixing materials in a twin screw extruder, extruding the mixture in the form of strands, chopping the strands into granules to form polyester resin pellets. The polymer pellets are molded to form an article of a desired shape in an embodiment.

The thermally conductive polymer composition can be molded to make an insulating article in another embodiment. An insulating article made by molding the thermally conductive polymer composition can be used as a heat dissipating material for electronic components, printed circuit board material, housing material for LED lighting, substrate material for small power supplies, and sealing material and case material for secondary batteries in an embodiment.

In another embodiment, the thermally conductive polymer composition can be in the form of a film. The film could be applied on a substrate which is used for mounting an electronic component so as to form an insulating layer in another embodiment. Thickness of the thermally conductive polymer film is 5 to 2000 μm in an embodiment, 25 to 1800 μm in another embodiment, 100 to 1500 μm in another embodiment.

The thermally conductive polymer composition can be in form of a paste in an embodiment. The thermally conductive polymer paste composition comprises the polymer, the BN filler and a solvent. The thermally conductive polymer paste composition can be formed by a well known method, mixing materials. Viscosity of the thermally conductive polymer paste composition is 10 to 300 Pa·s in an embodiment, 50 to 200 Pa·s in another embodiment, measured by Brookfield HAT with a spindle #14 at 10 rpm.

A method of manufacturing a thermally conductive polymer layer comprises steps of: applying a thermally conductive polymer paste composition on a substrate, the thermally conductive polymer paste composition comprises (a) a polymer, (b) a boron nitride filler comprising (b-1) a spherical boron nitride filler and (b-2) a sheet boron nitride filler, and (c) 2 to 60 parts by weight of a solvent; and drying the applied thermally conductive polymer paste composition.

The substrate can be selected from the group consisting of a metal substrate, a ceramic substrate, a glass substrate or a plastic film in an embodiment. The metal substrate is an aluminum substrate, a silver substrate or a copper substrate. The applying method is screen printing, knife coater, bar coater or rotogravure. The drying temperature is 50 to 200° C. in an embodiment, 70 to 150° C. in another embodiment, 85 to 120° C. in another embodiment. The drying time is 10 to 60 minutes in an embodiment, 15 to 40 minutes in another embodiment. The solvent evaporates during the drying step.

The thermally conductive polymer composition is explained hereafter.

### Polymer

The polymer is an organic polymer including copolymer and elastomer as well. The filler disperses in the organic polymer. The polymer is soluble at 25° C. in an organic solvent.

The polymer comprises a thermoplastic polymer, a thermoset polymer or a mixture thereof. The polymer is thermoplastic in an embodiment. The thermoplastic polymer is an engineering plastic that can be used at high temperatures of 100° C. or higher in another embodiment.

The polymer is a crystalline polymer in an embodiment. When the polymer is a crystalline polymer, melting point (Tm) of the polymer is 100° C. or higher in an embodiment, 150° C. or higher in another embodiment, and 230° C. or higher in another embodiment.

Glass transition point (Tg) of the polymer is −50 to 250° C. in an embodiment, −40 to 230° C. in another embodiment, −25 to 200° C. in another embodiment, 10 to 168° C. in another embodiment. The polymer starts alternating rigid crystalline and elastic amorphous regions at its glass transition point.

Molecular weight (Mw) of the polymer is 500 to 300,000 in an embodiment, 10,000 to 260,000 in another embodiment, 13,000 to 230,000 in another embodiment, 50,000 to 200,000 in another embodiment, and 100,000 to 190,000 in another embodiment.

The polymer can be selected from the group consisting of polyethylene, polypropylene, polyvinyl chloride, polystyrene, polyolefin, polyamide, polyester, AS resin, ABS resin, cyclic polyolefin, polycarbonate, polymethylpentene, polyether imide, polyphenyleneether, polyacetal, polyphenylene sulfide, liquid crystal polymer, polyallylate, polysulfone, polyether ether ketone (PEEK), polyethersulfone, polysulfone, polyamide imide, polyimide, fluorine, fluorinated resin, epoxy, novolak, isothiocyanate, melamine, urea, imide, aromatic polycarbodiimide, phenoxy, phenol, acrylic resin, vinylester, urethane, resol, silicone, acrylic polymer, polyisoprene, polybutadiene, polyisobutylene, styrene-butadiene copolymer, ethylene acrylic elastomer, nitrile elastomer (butadiene and acrylonitrile), EPDM (ethylene propylene diene) elastomer, polyurethane-polyether block copolymer, polyamide-polyether block copolymer, siloxane elastomer, chloroprene, fluoroelastomers, perfluoroelastomer, and a mixture thereof in another embodiment. The polymer comprises an elastomer in another embodiment. The elastomer can be an ethylene acrylic elastomer in another embodiment.

The polymer is 30 to 60 parts by weight in an embodiment, 35 to 55 parts by weight in another embodiment, 38 to 50 parts by weight in another embodiment against 100 parts by weight of the BN filler.

### Boron Nitride Filler

The boron nitride (BN) filler is a powder of a solid compound of boron (B) and nitrogen (N). The boron nitride filler is electrically insulating and thermally conductive. The BN filler comprises (b-1) 70 to 99 parts by weight of a spherical boron nitride filler, and (b-2) 1 to 30 parts by weight of a sheet boron nitride filler. By including these two kinds of BN fillers, spherical BN filler and sheet BN filler, the thermal conductivity can be improved.

The spherical BN filler has an aspect ratio (particle diameter:thickness) of 0.5:1 to 2:1 in an embodiment, about 1:1 in another embodiment. The particle diameter (D₅₀) of the spherical BN fillers is 1 to 150 μm in an embodiment, 5 to 100 μm in another embodiment and 10 to 80 μm in another embodiment. The particle diameter (D₅₀) of the spherical BN filler can be measured by laser diffraction analysis.

The surface area (SA) of the spherical BN filler is 1 to 50 m²/g in an embodiment, 1.5 to 25 m²/g in another embodiment, 2 to 15 m²/g in another embodiment. The surface area (SA) can be measured by BET (Brunauer, Emmett and Teller) method with a nitrogen adsorption/desorption isotherm.

The BN filler comprises (b-1) 70 to 99 parts by weight of the spherical BN filler, 75 to 98.5 parts by weight in another embodiment, 80 to 98 parts by weight in another embodiment, 90 to 97 parts by weight in another embodiment.

The sheet BN filler has an aspect ratio (particle diameter:thickness) of 100:1 to 10000:1 in an embodiment, 200:1 to 5000:1 in another embodiment, 400:1 to 2000:1 in another embodiment, 500:1 to 1000:1 in another embodiment, 600:1 to 900:1 in another embodiment.

The particle diameter (D₅₀) of the sheet BN filler is 1 to 50 μm in an embodiment, 3 to 35 μm in another embodiment, 5 to 28 μm in another embodiment, 7 to 20 μm in another embodiment. The particle diameter (D₅₀) of the sheet BN filler can be measured by laser diffraction analysis.

The thickness of the sheet BN filler is 5 to 500 nm in an embodiment, 7 to 300 nm in another embodiment, 8 to 150 nm in another embodiment, 10 to 70 nm in another embodiment. The thickness of the sheet BN filler can be measured by visually observing about 100 sheet BN filler particles with a microscope. The thickness can be calculated average from observed thickness of hundred particles of the sheet BN filler.

The surface area (SA) of the sheet BN filler is 4 to 50 m²/g in an embodiment, 5 to 35 m²/g in another embodiment, 6 to 26 m²/g in another embodiment, 7 to 18 m²/g in another embodiment. The surface area (SA) of the sheet BN filler can be measured by BET (Brunauer, Emmett and Teller) method with a nitrogen adsorption/desorption isotherm.

The sheet BN filler is 1 to 30 parts by weight in an embodiment, 1.5 to 25 parts by weight in another embodiment, 2 to 20 parts by weight in another embodiment, 3 to 10 parts by weight in another embodiment.

The sheet BN filler can be manufactured by using a supercritical fluid. For example, hexagonal BN (h-BN) particles can be exfoliated in a supercritical fluid made by high temperature and high pressure.

### Solvent

The thermally conductive polymer composition can optionally comprise a solvent in an embodiment. Especially when the thermally conductive polymer composition is in form of a paste, the solvent is added to the composition. The solvent adjusts viscosity of the paste to be preferable for applying on a substrate.

The solvent is 2 to 60 parts by weight in an embodiment, 9 to 52 parts by weight in another embodiment, 15 to 45 parts by weight in another embodiment, 20 to 40 parts by weight in another embodiment, against 100 parts by weight of the BN filler.

Boiling point of the solvent can be 120 to 350° C. in an embodiment, 160 to 320° C. in another embodiment, 200 to 290° C. in another embodiment.

The solvent can be selected from the group consisting of texanol, 1-phenoxy-2-propanol, terpineol, carbitol acetate, ethylene glycol, butyl carbitol, dibutyl carbitol, butyl acetate, dibuthyl acetate propylene glycol phenyl ether, ethylene glycol monobutyl ether and a mixture thereof in another embodiment.

### Additive

An additive such as a surfactant, a dispersing agent, a stabilizer and a plasticizer can be added to the polymer composition based on a desired property of the thermally conductive polymer composition in an embodiment.

### Examples

The present invention is illustrated by, but not limited to, the following examples.

### Preparation of Sheet BN Filler

The sheet BN filler was made by the following process with a supercritical fluid reactor process 200 (FIG. 2).

A hexagonal BN (h-BN) powder having particle diameter (D₅₀) of 20 μm was milled by using a horizontal planetary mill (Premium Line™ P-7, Fritsch GmbH). 0.5 g of the milled h-BN powder and 10 ml of 2M NaOH solution were put into a zirconia container with 2-mm-diameter zirconia balls. The rotational speed was 200 rpm and the milling time was 12 hours. The h-BN powder was repeatedly washed off with deionized water until the pH was about 7.

The h-BN powder was dispersed in water at concentration of 1 mg/ml. 200 ml of the h-BN powder aqueous solution was continuously injected from a container 201 into a tube heater 205 (C-22, V=133.8 ml, Hastelloy International) at 30 ml/min with a high pressure pump 203 (NP-KX-500, Nihon seimitsu kagaku Co., Ltd.). The tube heater 205 inside was kept at 400° C. and 25 MPa for 40 seconds to get the water supercritical. The h-BN powder aqueous solution flowed out from the tube heater 205 to a cooling line 207 where the h-BN powder aqueous solution was quenched to a room temperature at an atmospheric pressure. The h-BN powder aqueous solution was collected through a back-pressure regulator (TESCOM™ 26-1700 series, Emerson Electric Co.) that maintained a constant pressure and was designed to eject the solution when the pressure exceeds the set pressure.

Through the process above, the h-BN powder exfoliated to some extent in the water was obtained. The h-BN powder aqueous solution was again injected in the tube heater 205 through the container 201 to repeat the supercritical treatment. The process in the tube heater 205 and cooling line 207 was repeated 27 times to get the sheet BN powder sufficiently exfoliated. The sheet BN powder aqueous solution was collected in a vessel 211 by using a valve 209.

The sheet BN powder aqueous solution in the vessel 211 was filtered. The sheet BN filler was washed off with deionized water. The sheet BN filler obtained had average particle diameter (D₅₀) of 11.7 μm, thickness of 16 nm, surface area (SA) of 8.8 m²/g and aspect ratio (particle diameter:thickness) of 731:1.

The average particle diameter (D₅₀) was measured by laser diffraction analysis with a laser diffraction particle diameter analyzer (SALD-3000, SHIMADZU CORPORATION).

The surface area (SA) was measured by BET method with a nitrogen adsorption/desorption isotherm (BELSORP-18, Microtrac BEL Corporation).

The average thickness was measured with a transmission electron microscope (EM-002B, TOPCON Corporation) by observing hundred sheet BN filler particles.

A thermally conductive polymer paste composition was prepared by mixing ethylene acrylic elastomer (Vamac® G, E. I. Du Pont De Nemours and Company) and butyl acetate, a spherical BN filler (FP40, D₅₀: 40 μm, SA: 4 m²/g, Denka Company) and a flaky BN filler (SGP, D₅₀: 18 μm, thickness: 2 μm, aspect ratio: 10:1, SA: 1.8 m²/g, Denka Company) or the sheet BN filler prepared above. Amounts of the materials are shown in Table 1.

The thermally conductive polymer paste composition was casted by a bar coater on a plastic substrate which was a fluoropolymer base film. A silicone layer as a releasing layer was formed on the surface of the fluoropolymer base film. The casted thermally conductive polymer paste was dried in an oven at 100° C. for 30 minutes. The butyl acetate evaporated during the drying step. The thickness of the thermally conductive polymer composition film was 250 μm after drying.

The three layered film of the fluoropolymer base film, the silicone layer and thermally conductive polymer composition film, was cut into 19 square mm sheets. Four of the thermally conductive polymer composition films were laminated after removing the base film and silicon layer to form a film of 1 mm thick. The laminated film was placed on an aluminum plate of 150 square mm. The aluminum plate with the film was placed in a center cavity of 20 square mm and 0.7 mm deep, and vacuum-pressed at 1.7 MPa and 150° C. The vacuum-pressed thermally conductive film was cut into 15 square mm size for thermal conductivity measurement by laser flash method.

The thermal conductivity (TC) of the film obtained above was measured by a xenon flash apparatus (LFA 447 NanoFlash®, NETZSCH company) according to ASTM E-1461. TC is higher than 3.4 W/mK when using the sheet BN filler (Example 1 and 2) as shown in Table 1.

TABLE 1
(parts by weight)

| | Comparative | Comparative | | |
|---|---|---|---|---|
| | Example 1 | Example 2 | Example 1 | Example 2 |
| Polymer | 44 | 43 | 43 | 42 |
| Spherical BN filler¹⁾ | 100 | 96 | 96 | 85 |
| Flaky BN filler²⁾ | 0 | 4 | 0 | 0 |
| Sheet BN filler³⁾ | 0 | 0 | 4 | 15 |
| Solvent | 36 | 35 | 35 | 34 |
| TC (W/mK) | 3.03 | 3.38 | 3.53 | 3.41 |

¹⁾D₅₀: 40 μm, SA: 4 m²/g.
²⁾D₅₀: 20 μm, SA: 1.8 m²/g, thickness: 2 μm, aspect ratio: 10:1.
³⁾D₅₀: 11.7 μm, SA: 8.8 m²/g, thickness: 16 nm, aspect ratio: 731:1.

What is claimed is:

1. A thermally conductive polymer composition comprising:
(a) 30 to 60 parts by weight of a polymer, and
(b) 100 parts by weight of a boron nitride filler comprising:
(b-1) 70 to 99 parts by weight of a spherical boron nitride filler, and
(b-2) 1 to 30 parts by weight of a sheet boron nitride filler having a thickness of 5 to 500 nm, a surface area of 4 to 50 m²/g and an aspect ratio of 100:1 to 10000:1.

2. The thermally conductive polymer composition of claim 1, wherein a particle diameter (D₅₀) of the spherical boron nitride filler is 1 to 150 μm.

3. The thermally conductive polymer composition of claim 1, wherein a surface area of the spherical boron nitride filler is 1 to 50 m²/g.

4. The thermally conductive polymer composition of claim 1, wherein a particle diameter (D₅₀) of the sheet boron nitride filler is 1 to 50 μm.

5. The thermally conductive polymer composition of claim 1, wherein the polymer is selected from the group consisting of polyethylene, polypropylene, polyvinyl chloride, polystyrene, polyolefin, polyamide, polyester, AS resin, ABS resin, cyclic polyolefin, polycarbonate, polymethylpentene, polyether imide, polyphenyleneether, polyacetal, polyphenylene sulfide, liquid crystal polymer, polyallylate, polysulfone, polyether ether ketone (PEEK), polyethersulfone, polysulfone, polyamide imide, polyimide, fluorine, fluorinated resin, epoxy, novolak, isothiocyanate, melamine, urea, imide, aromatic polycarbodiimide, phenoxy, phenol, acrylic resin, vinylester, urethane, resol, silicone, acrylic polymer, polyisoprene, polybutadiene, polyisobutylene, styrene-butadiene copolymer, ethylene acrylic elastomer, nitrile elastomer (butadiene and acrylonitrile), EPDM (ethylene propylene diene) elastomer, polyurethane-polyether block copolymer, polyamide-polyether block copolymer, siloxane elastomer, chloroprene, fluoroelastomers, perfluoroelastomer, and a mixture thereof.

6. The thermally conductive polymer composition of claim 1, wherein a thermal conductivity of the thermally conductive polymer composition is 3.4 W/mK or higher measured according to ASTM E-1461.

7. A thermally conductive polymer film comprising the thermally conductive polymer composition of claim 1.

8. The thermally conductive polymer film of claim 7, wherein a thickness of the thermally conductive polymer film is 5 to 2000 μm.

9. A thermally conductive polymer paste composition comprising:
(a) 30 to 60 parts by weight of a polymer, and
(b) 100 parts by weight of a boron nitride filler comprising:
(b-1) 70 to 99 parts by weight of a spherical boron nitride filler, and
(b-2) 1 to 30 parts by weight of a sheet boron nitride filler having a thickness of 5 to 500 nm, a surface area of 4 to 50 m²/g and an aspect ratio of 100:1 to 10000:1; and
(c) 2 to 60 parts by weight of a solvent.

10. The thermally conductive polymer paste composition of claim 9, wherein a particle diameter (D₅₀) of the spherical boron nitride filler is 1 to 150 μm.

11. The thermally conductive polymer paste composition of claim 9, wherein a surface area of the spherical boron nitride filler is 1 to 50 m²/g.

12. The thermally conductive polymer paste composition of claim 9, wherein a particle diameter (D₅₀) of the sheet boron nitride filler is 1 to 50 μm.

13. The thermally conductive polymer paste composition of claim 9, wherein the polymer is selected from the group consisting of polyethylene, polypropylene, polyvinyl chloride, polystyrene, polyolefin, polyamide, polyester, AS resin, ABS resin, cyclic polyolefin, polycarbonate, polymethylpentene, polyether imide, polyphenyleneether, polyacetal, polyphenylene sulfide, liquid crystal polymer, polyallylate, polysulfone, polyether ether ketone (PEEK), polyethersulfone, polysulfone, polyamide imide, polyimide, fluorine, fluorinated resin, epoxy, novolak, isothiocyanate, melamine, urea, imide, aromatic polycarbodiimide, phenoxy, phenol, acrylic resin, vinylester, urethane, resol, silicone, acrylic polymer, polyisoprene, polybutadiene, polyisobutylene, styrene-butadiene copolymer, ethylene acrylic elastomer, nitrile elastomer (butadiene and acrylonitrile), EPDM (ethylene propylene diene) elastomer, polyurethane-polyether block copolymer, polyamide-polyether block copolymer, siloxane elastomer, chloroprene, fluoroelastomers, perfluoroelastomer, and a mixture thereof.

14. The thermally conductive polymer paste composition of claim 9, wherein the solvent is selected from the group consisting of texanol, 1-phenoxy-2-propanol, terpineol, carbitol acetate, ethylene glycol, butyl carbitol, dibutyl carbitol, butyl acetate, dibuthyl acetate propylene glycol phenyl ether, ethylene glycol monobutyl ether and a mixture thereof.

15. A method of manufacturing a thermally conductive polymer layer comprising:
applying a thermally conductive polymer paste composition on a substrate, the thermally conductive polymer paste composition comprising:
(a) 30 to 60 parts by weight of a polymer,
(b) 100 parts by weight of a boron nitride filler comprising:
(b-1) 70 to 99 parts by weight of a spherical boron nitride filler, and
(b-2) 1 to 30 parts by weight of a sheet boron nitride filler having thickness of 5 to 500 nm, surface area of 4 to 50 m²/g and aspect ratio of 100:1 to 10000:1, and
(c) 2 to 60 parts by weight of a solvent; and
drying the applied thermally conductive polymer paste composition.
